(19) United States
(12) Patent Application Publication
(10) Pub. No.: US 2014/0152922 A1
(43) Pub. Date: Jun. 5, 2014

(54) LIQUID CRYSTAL DISPLAY AND METHOD OF MANUFACTURING THE SAME

(71) Applicant: SAMSUNG DISPLAY CO., LTD., Yongin-city (KR)

(72) Inventors: JiHong BAE, Yongin-si (KR); Euna Kim, Seoul (KR); KeunChan Oh, Cheonan-si (KR); Suk Choi, Seongnam-si (KR)

(73) Assignee: Samsung Display Co., Ltd., Yongin-city (KR)

(21) Appl. No.: 13/856,857

(22) Filed: Apr. 4, 2013

(30) Foreign Application Priority Data
Dec. 5, 2012 (KR) 10-2012-0140393

(51) Int. Cl. G02F 1/1337

(52) U.S. Cl. CPC G02F 1/133711
USPC 349/15; 445/24

(57) ABSTRACT

A liquid crystal display apparatus comprises a first substrate including a first pretilting layer thereon, a second substrate facing the first substrate and including a second pretilting layer thereon, a liquid crystal layer disposed between the first pretilting layer and the second pretilting layer, and an electrode part provided on at least one of the first and second substrates to form a horizontal electric field or a fringe electric field. The first and second pretilting layer comprises a polymer polymerized from a chiral reactive mesogen having a chiral group and a reactive mesogenic group.

### CROSS-REFERENCE TO RELATED APPLICATION

This application claims priority from and the benefit of Korean Patent Application No. 10-2012-0140393, filed on Dec. 5, 2012, which is hereby incorporated by reference for all purposes as if fully set forth herein.

### BACKGROUND

1. Field

The present disclosure relates to a liquid crystal display and a method of manufacturing the same. More particularly, the present disclosure relates to a liquid crystal display having a fast response speed and a method of manufacturing the liquid crystal display.

2. Discussion of the Background

In general, a liquid crystal display includes a first substrate on which pixel electrodes are disposed, a second substrate on which a common electrode is disposed, and a liquid crystal layer interposed between the first substrate and the second substrate. The liquid crystal display forms an electric field between each pixel electrode and the common electrode, to change an amount of light transmitted through the liquid crystal layer and thereby display a desired image. The liquid crystal display includes a plurality of pixels that each include a pixel electrode.

In recent years, a liquid crystal display has been developed to display not only a two-dimensional image but also a three-dimensional image. When displaying a three-dimensional image, more image information is provided to a viewer than when the liquid crystal display displays a two-dimensional image. Therefore, the pixels need to be stably operated at higher speeds.

### SUMMARY

The present disclosure provides a liquid crystal display having a fast response speed and a high reliability.

The present disclosure provides a method of manufacturing the liquid crystal display.

Additional features of the invention will be set forth in the description which follows, and in part will be apparent from the description, or may be learned by practice of the invention.

Embodiments of the inventive concept provide a liquid crystal display apparatus comprising a first substrate including a first pretilting layer disposed thereon, a second substrate facing the first substrate and including a second pretilting layer disposed thereon, a liquid crystal layer disposed between the first pretilting layer and the second pretilting layer, and an electrode part provided on at least one of the first and second substrates, to form a horizontal electric field or a fringe electric field. The first and second pretilting layers comprise a polymer polymerized from a chiral reactive mesogen having a chiral group and a reactive mesogenic group. The chiral group comprises a photo-tunable chiral group a photo-tunable chiral group whose chirality changes by light exposed thereon.

Embodiments of the inventive concept provide a method of manufacturing a liquid crystal display apparatus comprising forming a first substrate, forming a second substrate, forming a liquid crystal composition including a liquid crystal and a chiral reactive mesogen, the chiral reactive mesogen including a chiral group and a reactive mesogenic group, applying light to the liquid crystal composition to form a first and second pretilting layers on the first and second substrates, respectively. The liquid crystal composition includes the chiral reactive mesogen in amount of about 0.001 percent by weight to 5 percent by weight relative to the total weight of the liquid crystal composition.

According to the above, the liquid crystal display in an embodiment of the present invention has higher response time and contrast ratio, resulting in providing high image quality.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram showing a liquid crystal display according to an exemplary embodiment of the present disclosure.

FIG. 2 is a plan view showing one pixel of FIG. 1.

FIG. 3 is a cross-sectional view taken along a line I-I′ of FIG. 2.

FIG. 4 is a flowchart showing a manufacturing a liquid crystal display according to an exemplary embodiment of the present disclosure.

FIGS. 5A and 5B are graphs respectively showing a voltage holding ratio in accordance with an exposure time, in a conventional liquid crystal display and a liquid crystal display according to an exemplary embodiment of the present disclosure, when a liquid crystal layer is exposed to a light.

FIGS. 6A and 6B are graphs respectively showing a voltage holding ratio in accordance with an exposure time, in a conventional liquid crystal display and a liquid crystal display according to an exemplary embodiment of the present disclosure, when a liquid crystal layer is exposed to heat and an electric field.

FIG. 7 is a plan view showing one pixel of a liquid crystal display according to an exemplary embodiment of the present disclosure.

FIG. 8 is a cross-sectional view taken along a line II-II′ of FIG. 7.

FIG. 9 is a plan view showing one pixel of a liquid crystal display according to an exemplary embodiment of the present disclosure.

FIG. 10 is a cross-sectional view taken along a line III-III′ of FIG. 9.

### DETAILED DESCRIPTION OF THE ILLUSTRATED EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

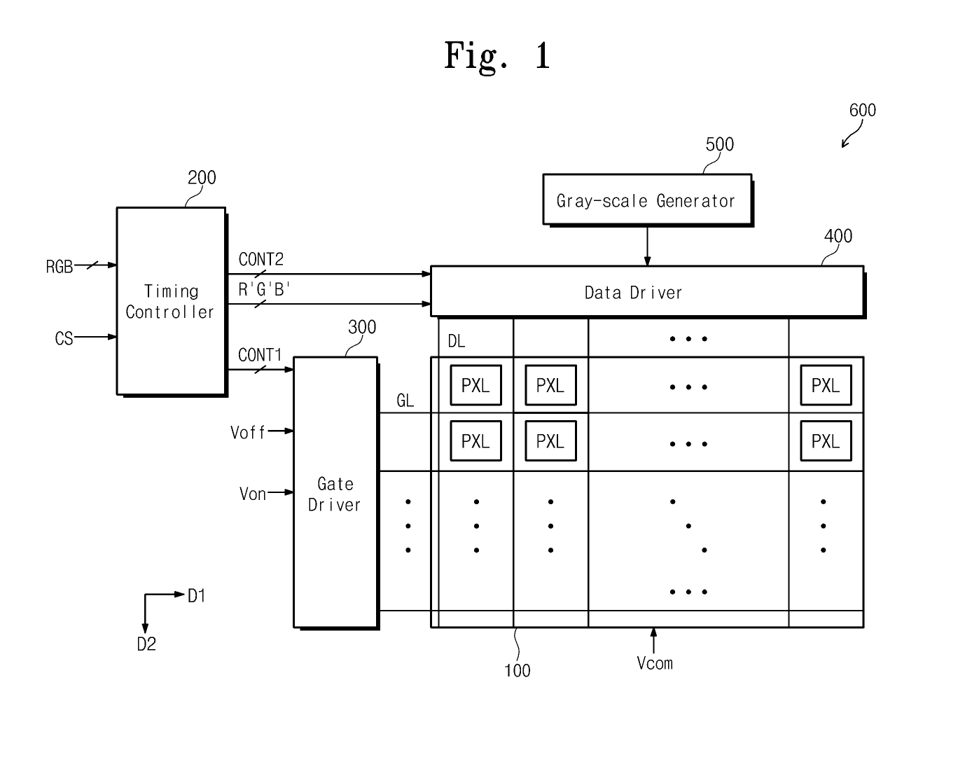

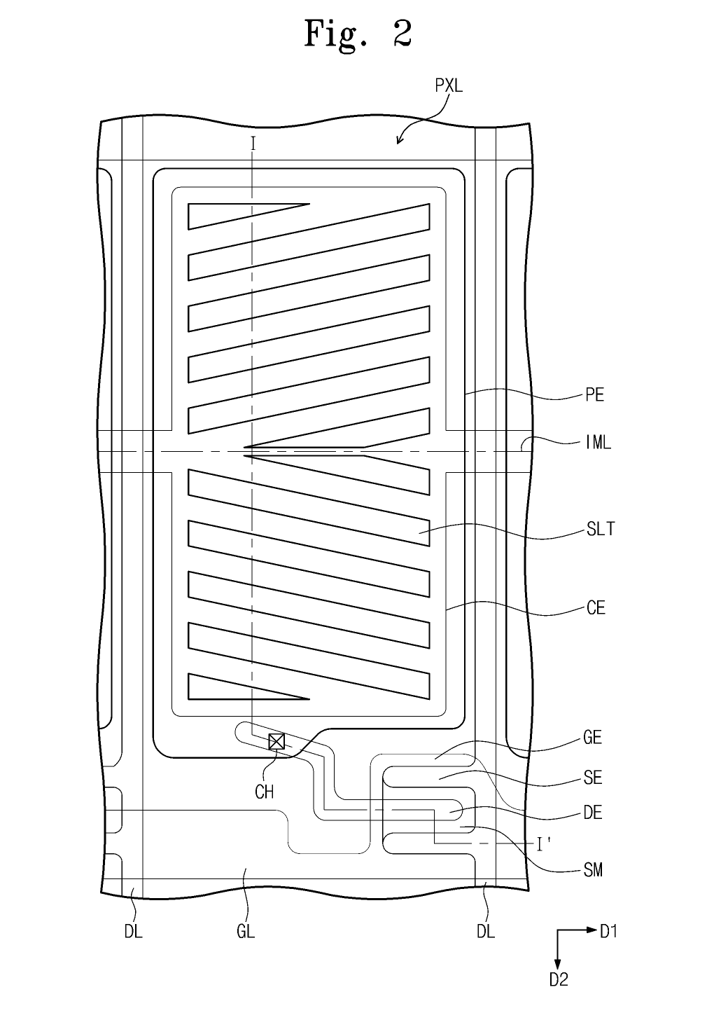

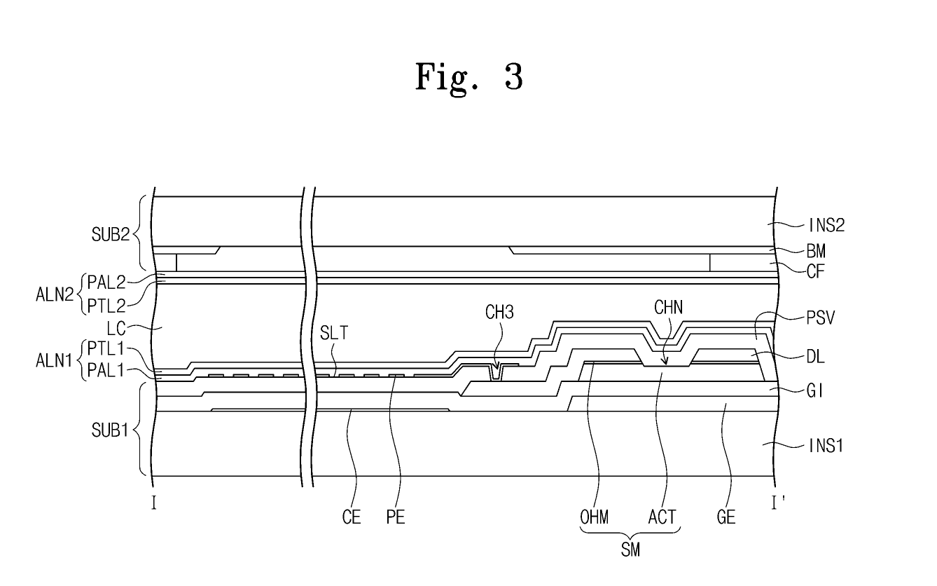

FIG. 1 is a block diagram showing a liquid crystal display 600 according to an exemplary embodiment of the present disclosure, FIG. 2 is a plan view showing one pixel of FIG. 1, and FIG. 3 is a cross-sectional view taken along a line I-I′ of FIG. 2. Referring to FIG. 1, the liquid crystal display 600 includes a liquid crystal display panel 100, a timing controller 200, a gate driver 300, a data driver 400, and a gray-scale voltage generator 500.

The liquid crystal display panel 100 is connected to a plurality of signal lines and includes a plurality of pixels PXL arranged in a matrix. The signal lines include a plurality of gate lines GL supplied with gate signals and a plurality of data lines DL supplied with data voltages. The gate lines GL extend in a row direction, i.e., a first direction D1, and are substantially parallel to each other. The data lines DL extend in a column direction, i.e., a second direction D2, and are substantially parallel to each other.

The pixels PXL have the same structure, and thus, only one pixel PXL will be described in detail with reference to FIGS. 2 and 3 as a representative example. Referring to FIGS. 2 and 3, the liquid crystal display 600 includes a first substrate SUB1, a first alignment layer ALN1 disposed on the first substrate SUB1, a second substrate SUB2 facing the first substrate SUB1, a second alignment layer ALN2 disposed on the second substrate SUB2, and a liquid crystal layer LC disposed between the first alignment layer ALN1 and the second alignment layer ALN2.

The first substrate SUB1 includes a first insulating substrate INS1, the gate lines GL, the data lines DL, and the pixels PXL. The first insulating substrate INS 1 has a rectangular shape and includes a transparent insulating material.

A gate insulating layer GI is disposed on the first insulating substrate INS 1 to cover the gate lines GL. The gate insulating layer GI is formed of an insulating material, e.g., silicon nitride, silicon oxide, or the like. The gate insulating layer GI is disposed between the gate lines GL and the data lines DL.

Each pixel PXL is connected to a corresponding gate line GL and a corresponding data line DL. Each pixel PXL includes a thin film transistor, the pixel electrode PE connected to the thin film transistor, a passivation layer PSV covering the pixel electrode PE, and a common electrode CE spaced apart from and overlapped with the pixel electrode PE. In the present exemplary embodiment, the pixel electrode PE is disposed on the common electrode CE, but the present disclosure is not limited thereto. That is, the pixel electrode may be disposed under the common electrode while interposing an insulating layer therebetween, when the pixel electrode and the common electrode form a fringe electric field.

The common electrode CE is disposed on the first insulating substrate INS 1. When viewed in a plan view, the common electrode CE is disposed between adjacent gate lines GL. A portion of the common electrode CE extends in the first direction D1 to and adjacent pixel PXL. The common electrode CE is supplied with the same voltage in each pixel PXL.

The common electrode CE has a rectangular shaped portion in each pixel PXL, but is not limited thereto. The common electrode CE may have various shapes in accordance with the shape of a pixel, for example. The portion of the common electrode CE in each pixel PXL may be rectangular and does not include a pattern, e.g., a slit.

The thin film transistor includes a gate electrode GE, the gate insulating layer GI, a semiconductor pattern SM, a source electrode SE, and a drain electrode DE. The gate electrode GE may be protruded from the gate line GL or may be provided on a portion of the gate line GL. The gate insulating layer GI is disposed on the entire surface of the first insulating substrate INS 1, to cover the gate line GL, the gate electrode GE, and the common electrode CE.

The semiconductor pattern SM is disposed on the gate insulating layer GI. The semiconductor layer SM is disposed on the gate electrode GE with the gate insulating layer GI disposed therebetween. The semiconductor pattern SM is partially overlapped with the gate electrode GE. The semiconductor pattern SM includes an active pattern ACT disposed on the gate insulating layer GI and an ohmic contact layer OHM disposed on the active pattern ACT.

The source electrode SE is branched from the data line DL. The drain electrode DE is spaced apart from the source electrode SE, with the semiconductor pattern SM disposed therebetween. Accordingly, an upper surface of the active pattern ACT is exposed between the source electrode SE and the drain electrode DE and serves as a channel portion CHN, e.g., a conductive channel, between the source electrode SE and the drain electrode DE, in response to the application of the voltage to the gate electrode GE. The source electrode SE and the drain electrode DE overlap portions of the semiconductor layer SM other than the channel portion CHN.

The passivation layer PSV is disposed on the first insulating substrate INS1 and covers the data line DL, the source electrode SE, the drain electrode DE, and the channel portion CHN. The passivation layer PSV is provided with a contact hole CH formed therethrough, to expose a portion of the drain electrode DE.

The pixel electrode PE is disposed on the passivation layer PSV to overlap with the common electrode CE and is connected to the drain electrode DE through the contact hole CH. Thus, a portion of the pixel electrode PE is overlapped with the drain electrode DE, when viewed in a plan view.

When viewed in a plan view, the pixel electrode PE has the rectangular shape, but is limited thereto. That is, the pixel electrode PE may have various shapes in accordance with the shape of the pixel PXL. The pixel electrode PE includes a plurality of slits SLT. The pixel electrode PE includes a trunk portion and a plurality of branch portions extended from the trunk portion. The branch portions are spaced apart from each other at regular intervals. The branch portions of the pixel electrode PE form the fringe electric field, in cooperation with the common electrode CE.

The first alignment layer ALN1 is disposed on the pixel electrode PE to pretilt liquid crystal molecules of the liquid crystal layer LC. The first alignment layer ALN1 includes a first preliminary alignment layer PAL1 disposed on the pixel electrode PE and a first pretilting layer PTL1 disposed on the first preliminary alignment layer PAL1. The first preliminary alignment layer PAL1 includes a polymer, such as a polyimide, polyamic acid, or the like, and becomes a main chain, to which a chiral reactive mesogen is attached.

The first pretilting layer PTL1 includes a polymer, polymerized from a chiral reactive mesogen having chiral group and a reactive mesogenic group. The term of “mesogen” used herein refers to a photo-linked, low-molecular weight polymer or a high-molecular weight copolymer, both of which having a mesogenic group having liquid crystal properties.

The first pretilting layer PTL1 comprises a polymer polymerized from at least one type of chiral reactive mesogen represented by Chemical Formula 1:

(R*-(A¹-Z¹)ₘ₁)ₖ-Q [Chemical Formula 1]

In Chemical Formula 1, (R*-(A¹-Z¹)ₘ₁)ₖ— denotes the reactive mesogenic group, and Q denotes the chiral group.

In Chemical Formula 1, R* denotes P-Sp-, H, or L as defined below, or a straight-chain or branched alkyl having 1 to 25 C atoms, in which, one or more non-adjacent CH₂ groups may each be replaced, independently of one another, by —C(R^{X})═C(R^{X})—, —C≡C—, —N(R^{X})—, —O—, —S—, —CO—, —CO—O—, —O—CO—, or —O—CO—O—, in such a way that O and/or S atoms are not linked directly to one another. In addition, one or more H atoms may be replaced by F, Cl, Br, I, CN, or P-Sp-. The H atoms may be replaced by the same group of different groups.

In Chemical Formula 1, P denotes CH₂═C(CH₃)—COO—, and Sp denotes a spacer group or a single bond.

In Chemical Formula 1, L denotes P-Sp-, —OH, —CH₂OH, F, Cl, Br, I, —CN, —NO₂, —NCO, —NCS, —OCN, —SCN, —C(═O)N(RX)₂, —C(═O)Y¹, —C(═O)R^{X}, —N(R^{X})₂, an optionally substituted silyl or aryl group having 6 to 20 C atoms, or a straight-chain or branched alkyl, alkoxy, alkylcarbonyl, alkoxycarbonyl, alkylcarbonyloxy, or alkoxycarbonyloxy group having 1 to 25 C atoms, in which one or more H atoms may be replaced by any of F, Cl, or P-Sp-.

In Chemical Formula 1, Y¹ denotes a halogen, and R^{X} denotes P-Sp-, H, a halogen, a straight-chain or branched or cyclic alkyl having 1 to 25 C atoms, in which one or more non-adjacent CH₂ groups may be replaced by —O—, —S—, —CO—, —CO—O—, —O—CO—, —O—CO—O— in such a way that O and/or S atoms are not linked directly to one another, and in which, one or more H atoms may be replaced by F, Cl or P-Sp-, an optionally substituted aryl or aryloxy group having 6 to 40 C atoms, or an optionally substituted heteroaryl or heteroaryloxy group having 2 to 40 C atoms.

In Chemical Formula 1, A¹ denotes an aromatic, heteroaromatic, alicyclic, or heterocyclic group, generally having 4 to 25 C atoms, which may also contain fused rings, and which is optionally mono- or polysubstituted by L, which comprises phenyl, thiophenyl, 1,4-phenylene, naphthalene-1,4-diyl or naphthalene-2,6-diyl, in which, one or more CH groups in these groups may be replaced by N, cyclohexane-1,4-diyl, in which, one or more non-adjacent CH₂ groups may be replaced by O and/or S, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl. These groups may be unsubstituted or may be mono- or polysubstituted by L.

In Chemical Formula 1, each Z¹ may be —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)nl-, —CF₂CH₂—, —CH₂CF₂—, —(CF₂)nl-, —CH═CH—, —CF═CF—, —C≡C—, —CH═CHCOO—, —OCO—CH═CH—, CRoRoo, or a single bond. Ro and Roo are each independently selected from H or an alkyl having 1 to 12 C atoms. Also Z¹ may also be selected from the compounds of A¹. Z¹ and A¹ may be the same or different.

In Chemical Formula 1, m1 is 0, 1, 2, 3 or 4, n1 is 1, 2, 3 or 4, and k is 1, 2, 3, 4, 5 or 6. At least one of A¹ and Z¹ contains at least one radical R* or L, which contains the P-Sp-group.

The term “spacer group”, also referred to as “Sp”, may be as described in, for example, Pure Appl. Chem. 73(5), 888 (2001) and C. Tschierske, G. Pelzl, S. Diele, Angew. Chem. 2004, 116, 6340-6368. Unless indicated otherwise, the term “spacer group” or “spacer” refers to a flexible group which connects the mesogenic group and the polymerisable group(s) to one another in a polymerized mesogenic compound (“RM”).

In Chemical Formula 1, Q denotes a k-valent chiral group, which is unsubstituted or is optionally mono or polysubstituted by L. Particularly, the compounds of Chemical Formula 1 may include a monovalent group Q of Chemical Formula II below. The monovalent group Q may be a photo-tunable chiral group whose chirality changes due to exposure to light.

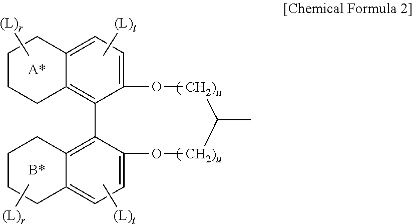

In Chemical Formula 2, L denotes P-Sp-, OH, CH₂OH, F, Cl, Br, I, —CN, —NO₂, —NCO, —NCS, —OCN, —SCN, —C(═O)N(R_{X})₂, —C(═O)Y¹, —C(═O)R^{X}, —N(R^{X})₂, an optionally substituted silyl, an optionally substituted aryl having 6 to 20 C atoms, or a straight-chain or branched alkyl, alkoxy, alkylcarbonyl, alkoxycarbonyl, alkylcarbonyloxy, or alkoxycarbonyloxy group, having 1 to 25 C atoms, in which, one or more H atoms may be replaced by F, Cl, or P-Sp-.

In Chemical Formula 2, Y¹ denotes a halogen, and r is 0, 1, 2, 3 or 4. In each occurrence, L and/or r may be the same or different.

In Chemical Formula 2, each A* and B* are independently selected from a fused benzene, cyclohexane, or cyclohexene. Each t is independently selected from 0, 1 or 2, and each u is independently selected from 0, 1 or 2.

Further exemplary compounds of the Chemical Formula 1 contain a divalent group Q of the following Chemical Formula 3

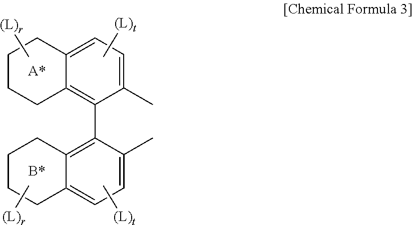

In Chemical Formula 3, L, r, t, A* and B* are as described above.

In an exemplary embodiment of the present invention, the compounds of Chemical Formula 3 may be selected from the compounds of the following sub-formulas:

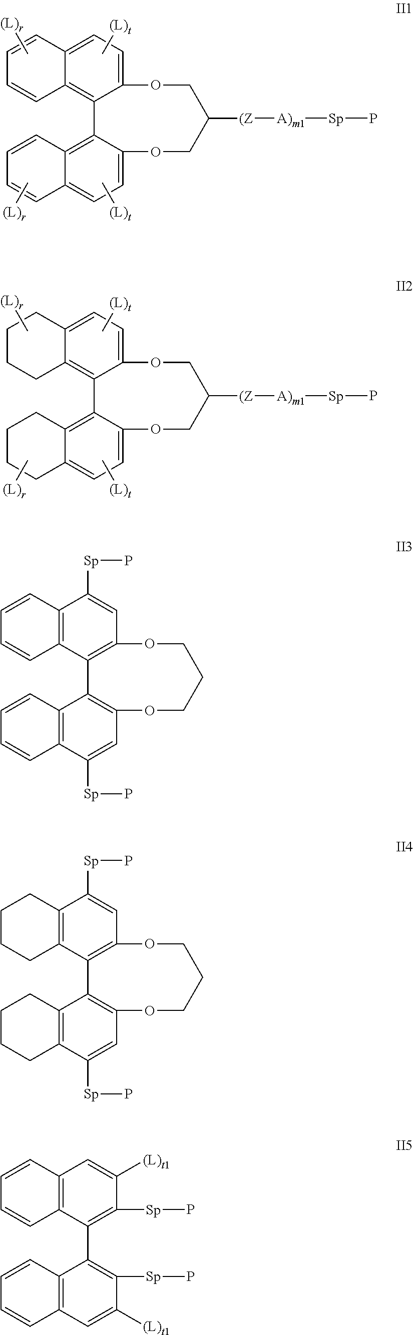

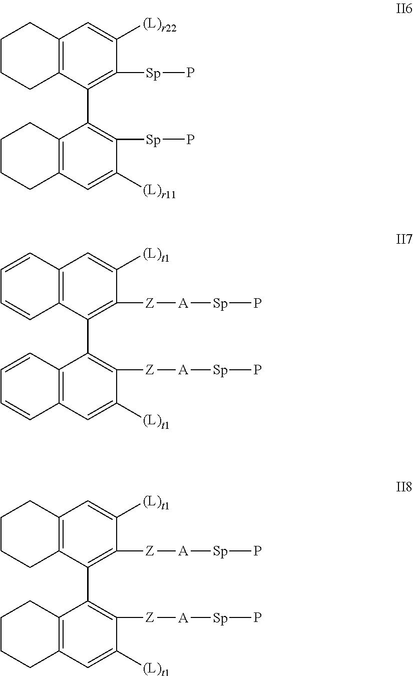

In the sub-formulas, Sp denotes a spacer group or a single bond, and L, P, Sp, m1, r and t are as described above. Each Z is independently selected from the compounds of Z¹, and each A is independently selected from the compounds of or A¹. Each t1 is independently 0 or 1.

The second substrate SUB2 includes a second insulating substrate INS2, a color filter CF, a black matrix BM, and a second alignment layer ALN2. A color filter CF is disposed in each pixel PXL to adjust the color of light passing through the each pixel PXL. The black matrix BM surrounds each color filter CF to reduce light leakage.

The second alignment layer ALN2 is disposed on the color filter CF to pretilt the to liquid crystal molecules of the liquid crystal layer LC. The second alignment layer ALN2 includes a second preliminary alignment layer PAL2 disposed on the color filter CF, and a second pretilting layer PTL2 disposed on the second preliminary alignment layer PAL2.

The second preliminary alignment layer PAL2 includes a polymer, such as polyimide, polyamic acid, or the like, and becomes a main chain to which a chiral reactive mesogen, which is polymerized from the second pretilting layer PTL2, is attached. The second pretilting layer PTL2 includes the polymer polymerized with the chiral reactive mesogen of Chemical Formula 1, which has the chiral group and the reactive mesogenic group. The second pretilting layer PTL2 may include a polymer polymerized with a different chiral reactive mesogen from the reactive mesogen of the first pretilting layer PTL1.

The liquid crystal layer LC is disposed between the first substrate SUB1 and the second substrate SUB2. The liquid crystal layer LC may be a composition of various liquid crystal molecules. The liquid crystal layer LC may include low viscosity liquid crystal molecules to improve a response time. The low viscosity liquid crystal molecules may include at least one type of alkenyl liquid crystal molecule selected from the compounds of Chemical Formulas 5, or at least one type of alkoxy liquid crystal molecule selected from the compounds of Chemical Formulas 6.

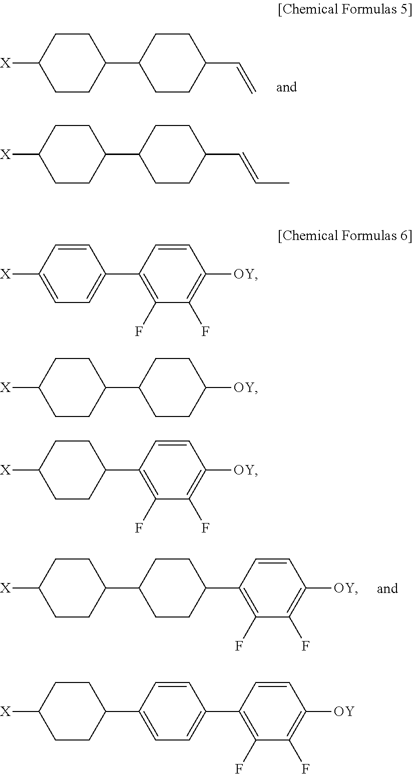

In Chemical Formulas 5 and 6, x and y independently denote an alkyl having 2 to 5 C atoms.

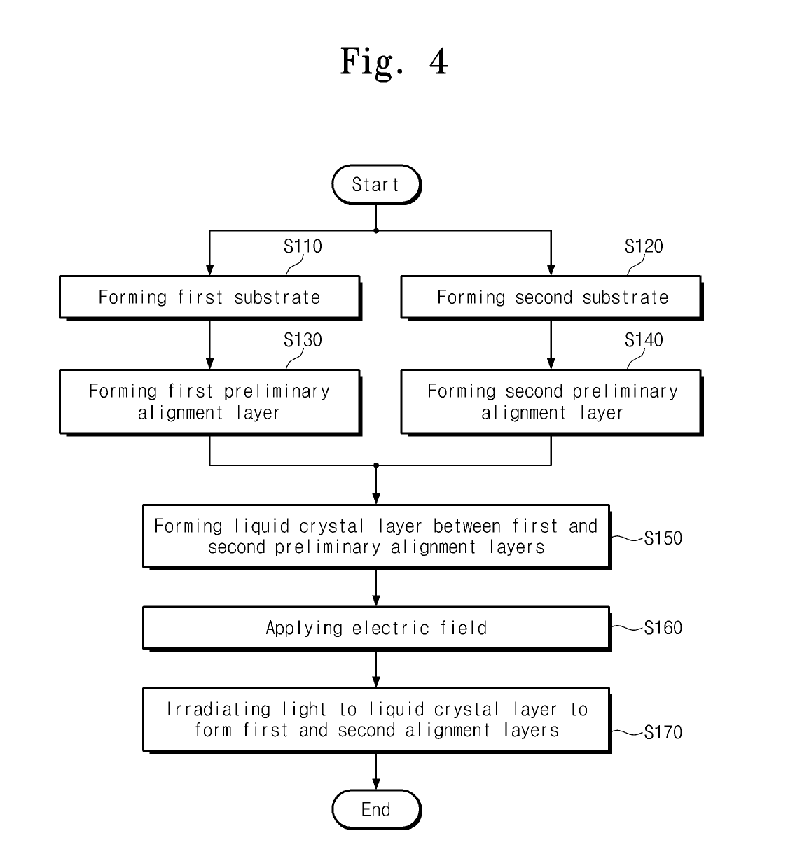

FIG. 4 is a flowchart showing the manufacturing a liquid crystal display, according to an exemplary embodiment of the present disclosure. Referring to FIG. 4, first and second substrates are manufactured (S110, S120).

The first substrate includes a first insulating substrate, a common electrode disposed on the first insulating substrate, and a pixel electrode having a plurality of branches. The second substrate includes a second insulating substrate facing to the first insulating substrate and a color filter and a black matrix that are disposed on the second insulating substrate.

After the first and the second substrates are manufactured, a first preliminary alignment layer is formed on the first substrate, and a second preliminary alignment layer is formed on the second substrate (S130, S140). The first preliminary alignment layer is provided on the pixel electrode, and the second preliminary alignment layer is provided on the color filter.

The first and second preliminary alignment layers may be coated on the first and second substrates by a proper scheme, such as, by an ink-jet method or by a roll-printing method. The first and second preliminary alignment layers may include a polymer such as polyimide, polyamic acid, or the like, and becomes a main chain to which a chiral reactive mesogen, which is polymerized from the first and second pretilting layers, are attached.

In an exemplary embodiment of the present invention, a preliminary alignment process may be performed on the first and second preliminary alignment layers, so as to facilitate the alignment of the completed first and second alignment layers. The preliminary alignment process may be a rubbing process or a photo-alignment process performed on the first and second preliminary alignment layers.

Next, a liquid crystal layer is formed between the first and second preliminary alignment layers, and the first and second substrates are coupled (S150). In an exemplary embodiment of the present invention, the first and second substrates are coupled while the liquid crystal layer is disposed therebetween. In another exemplary embodiment of the present invention, the liquid crystal layer is injected between the first and second preliminary alignment layers, after coupling of the first and second substrates.

The liquid crystal layer includes a liquid crystal composition having liquid crystal molecules and a chiral reactive mesogen. The liquid crystal molecules may include at least one of the compounds of the Chemical Formula 5 or at least one of the compounds of the Chemical Formula 6. The liquid crystal layer may include the chiral reactive mesogen of Chemical Formula 1, in an amount of about 0.001 percent by weight to about 5 percent by weight, relative to the total weight of the liquid crystal composition.

The liquid crystal composition may further include an amount of a photo-initiator sufficient to initiate a polymerization reaction of the chiral reactive mesogen. The photo-initiator may be provided, for example, in an amount of about 0.01 percent by weight to about 1 percent by weight, relative to the total weight of the liquid crystal composition. The photo-initiator may be decomposed to radicals by absorbing light, such as long-wavelength UV, to promote a photo-activated polymerization reaction of the chiral reactive mesogen. The photo-initiator may include at least one compound of Chemical Formulas 7.

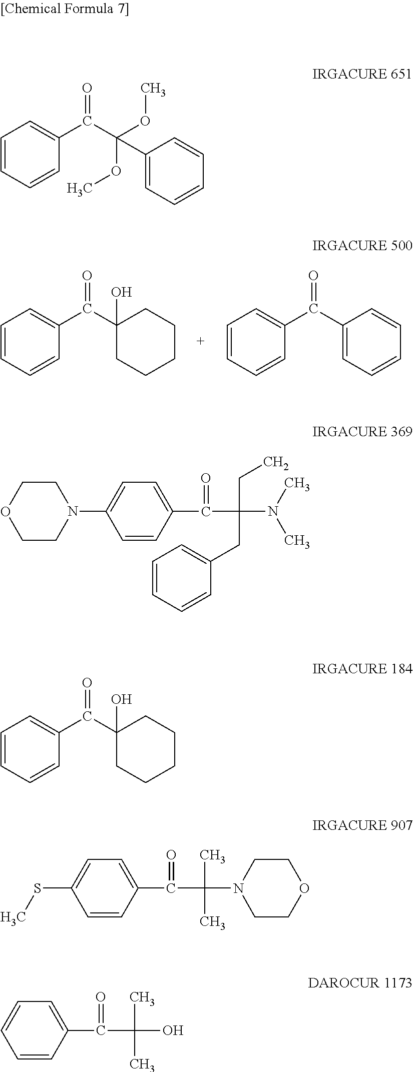

After coupling the first and second substrates, a fringe electric field is formed between the pixel electrode and the common electrode, when a voltage is applied to the pixel electrode and the common electrode (S160). A predetermined voltage may be applied to the pixel electrode, and a ground voltage or zero voltage may be applied to the common electrode. The predetermined voltage and the ground voltage may be applied to the pixel electrode and the common electrode for about 1 second to about 300 seconds. The predetermined voltage may be about 5V to about 20V.

The electric field aligns the liquid crystal molecules in one or more directions. While the electric field is formed, a first exposure process is performed, which includes exposing the liquid crystal layer to light such as UV light. The light may be radiated through one or both of the first and second substrates. The light may have a wavelength of about 365 nm and an intensity of about 10 mW/cm² to about 100 mW/cm².

When the electric field is applied to the liquid crystal molecules, the liquid crystal molecules adjacent to the first and second preliminary alignment layers are arranged in response to the electric field. When light is applied to the liquid crystal layer in such a state, the chiral reactive mesogen in the liquid crystal layer is polymerized and attached to the first and second preliminary alignment layers, to form first and second pretilting layers, respectively. Thus, a first alignment layer including the first preliminary alignment layer and the first pretilting layer, and a second alignment layer including the second preliminary alignment layer and the second pretilting layer, are formed (S170).

The first and second pretilting layers are cured with the substantially same tilt angle as that of the liquid crystal molecules. In more detail, when the electric field is applied to the liquid crystal molecules, the chiral reactive mesogens are arranged in the same direction as that of the adjacent liquid crystal molecules. As the chiral reactive mesogen is levorotatory or dextrorotatory, the liquid crystal molecules are also arranged according to the chirality of reactive mesogen, i.e., levo- or dextro-rotated. When the UV light is applied in this state, the functional groups of the chiral reactive mesogen react with each other to form a network. As a result, the chiral reactive mesogen forms the first and second pretilting layers, which are attached to the first and second preliminary alignment layers as the side chains, respectively. The first and second pretilting layers have a specific directionality, according to an average alignment direction of the liquid crystal molecules. Thus, although the electric field disappears, the liquid crystal molecules disposed adjacent to the network are pretilted.

The first exposure process may be performed at a temperature range of about 0° C. to about 60° C. When the first exposure process is performed in a temperature range of about 0° C. to about 60° C., which is a comparatively lower temperature than that of the conventional art, the order of the liquid crystal molecules increases.

Also, the chiral has the chirality then the liquid crystal molecules has a higher probability to be arranged according to the chirality of the reactive mesogen, i.e. the levo- or dextro-rotational properties, resulting in an increase of the order of the liquid crystal molecules, particularly, the order of the directors of the liquid crystal molecules. Moreover, the chirality of the chiral reactive mesogen can be controlled by a racemization reaction, according to the wavelength, intensity, etc., of light radiated thereon. As such, the order of the liquid crystal molecules can be controlled by changing the light's wavelength, intensity, or the like.

Then, a second exposure process may be performed while no electric field is applied to the liquid crystal layer. The second exposure process may be a fluorescence exposure process, in which ultra violet rays are radiated onto the liquid crystal layer, to polymerize the remaining unreacted chiral mesogen.

The liquid crystal display as explained above has a higher response speed and contrast ratio, resulting in improved image quality. Table 1 shows response time of a conventional liquid crystal display, and a liquid crystal display employing the chiral reactive mesogen, according to an exemplary embodiment of the present invention.

In Table 1, the conventional liquid crystal display and the exemplary liquid crystal display have the same structure, except for the liquid crystal composition and alignment layers. The conventional liquid crystal display includes a liquid crystal composition that lacks a chiral reactive mesogen. On the contrary, the exemplary liquid crystal display includes a liquid crystal composition having the chiral reactive mesogen in an range of 0.05 percent by weight, relative to the to the total weight of the liquid crystal composition. For making the liquid crystal display of the present invention, light exposure conditions are changed to polymerize the chiral reactive mesogen with different irradiation energies.

TABLE 1

| | amount of chiral | irradiation | response | improvement |
|---|---|---|---|---|
| | reactive mesogen | energy of | time | of response |
| | (% by weight) | UV (J) | (Toff, ms) | time (%) |
| conventional | 0 | 0 | 15.26 | standard |
| liquid crystal | | | | |
| display | | | | |
| liquid crystal | 0.05 | 3 | 12.78 | 19.4 |
| display | | | | |
| (example 1) | | | | |
| liquid crystal | 0.05 | 6 | 12.30 | 24.1 |
| display | | | | |
| (example 2) | | | | |

As shown in Table 1, the response times of the exemplary liquid crystal displays are improved by about 20%, as compared to that of the conventional liquid crystal display. This improvement is due to the liquid crystal molecules being sufficiently pretilted in an area where a fringe electric field is formed, as well as the high order and elasticity of the liquid crystal molecules. The increase of elasticity is presumed to be caused by the liquid crystal molecules rotating in one direction, according to the chirality of the polymerized reactive mesogen. Also, in the conventional liquid crystal display, since liquid crystal molecules are arranged in a direction of a major axis, the direction each liquid crystal molecule is twisted may vary. As such, the liquid crystal molecules are more resistant to being pretilted.

On the contrary, the liquid crystal molecules of the present display are arranged in a higher ordered state, using the chirality of the chiral reactive mesogen. As such, the liquid crystal molecules are more easily pretilted. In addition, a higher the contrast ratio than that of the conventional liquid crystal display can be obtained, due to the higher order of the liquid crystal molecules. Moreover, the present liquid crystal display has a higher voltage holding ratio with respect to the application of heat, light, and electric field stresses.

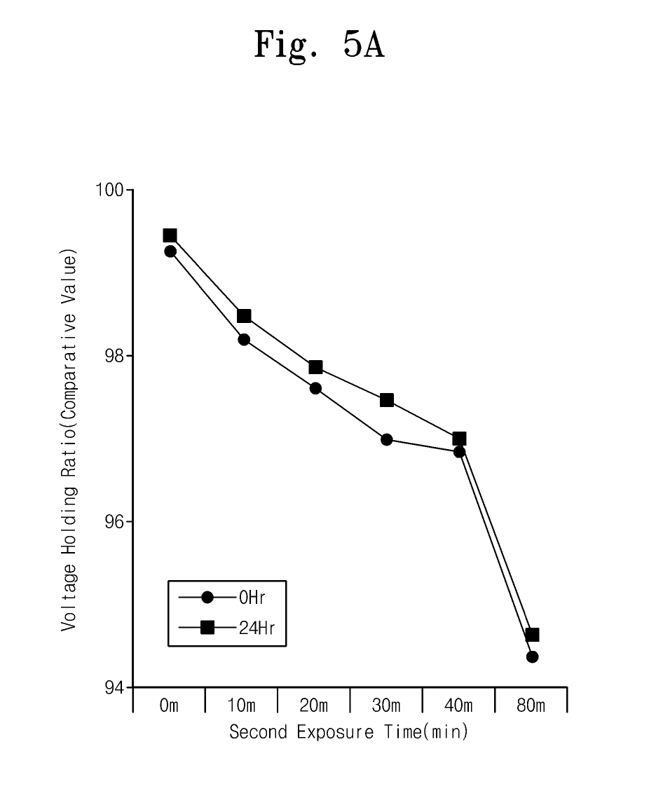

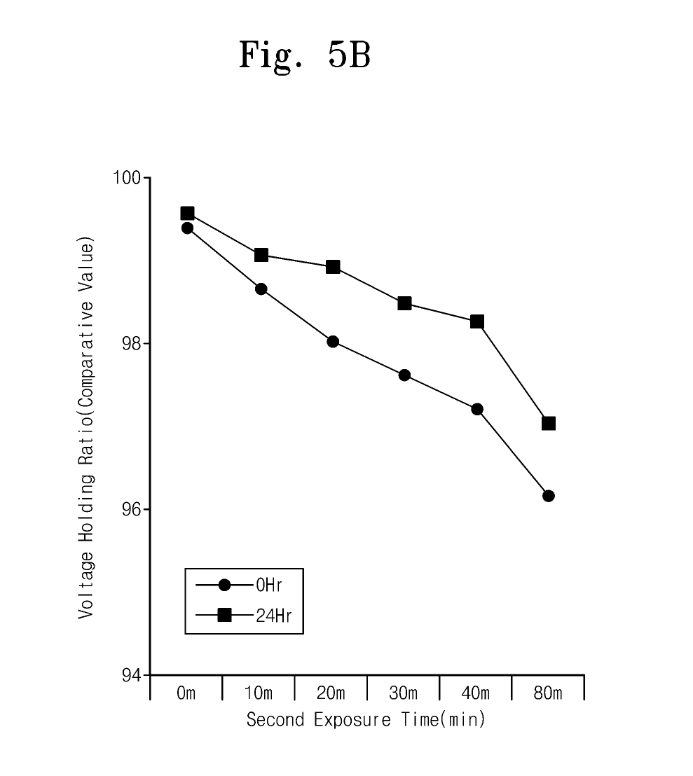

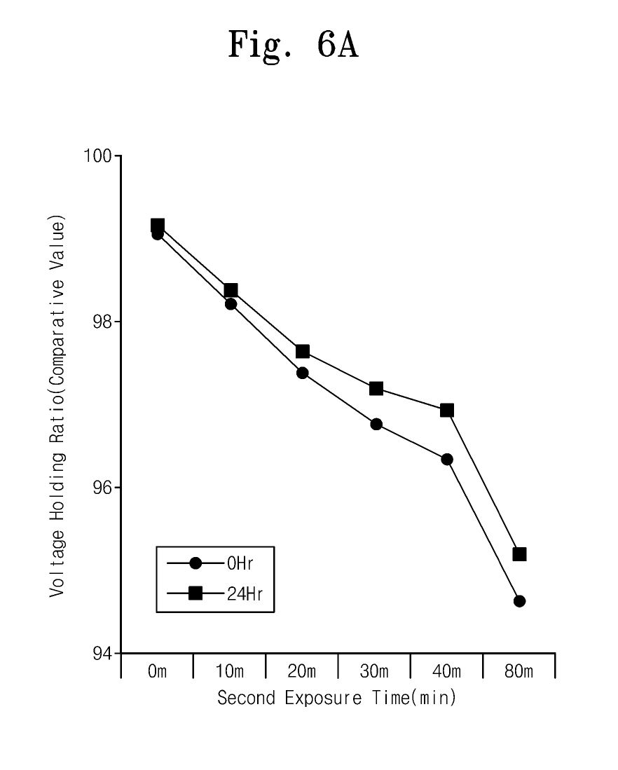

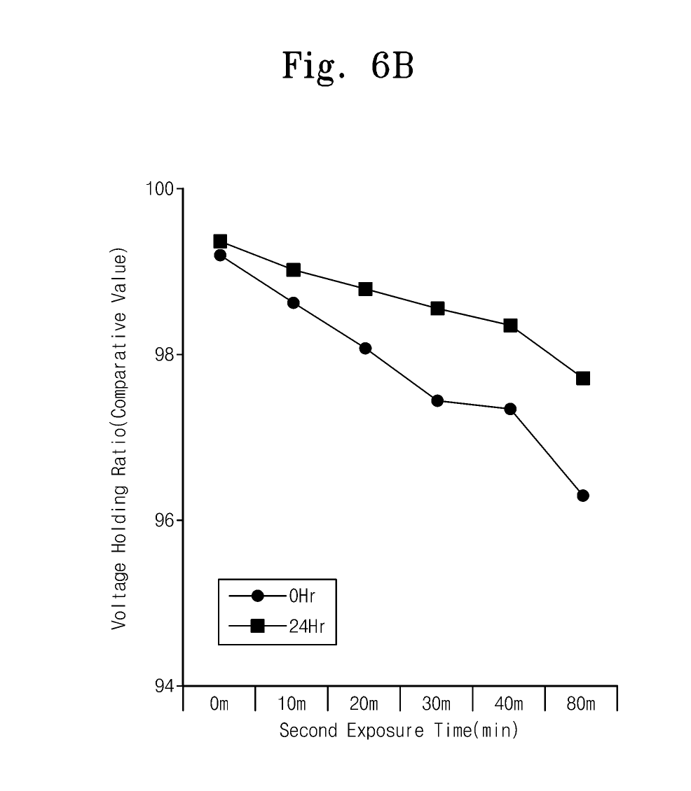

FIGS. 5A and 5B are graphs respectively showing a voltage holding ratio in accordance with an exposure time, during the second exposure process, in a conventional liquid crystal display and a liquid crystal display according to an exemplary embodiment of the present disclosure, when liquid crystal layers are exposed to light. FIGS. 6A and 6B are graphs respectively showing a voltage holding ratio in accordance with exposure time, during the second exposure process, in a conventional liquid crystal display and a the present liquid crystal display, when a liquid crystal layer is exposed to heat and an electric field.

Referring to FIGS. 5A and 5B, the conventional liquid crystal display and the present liquid crystal display have the same structure, except for the liquid crystal composition and alignment layers. The conventional liquid crystal display includes a liquid crystal composition that lacks a chiral reactive mesogen. On the contrary, the exemplary liquid crystal display includes a liquid crystal composition having a chiral reactive mesogen, at about 0.4 percent by weight, relative to the to the total weight of the liquid crystal composition. In FIGS. 5A and 5B, the data taken at 0 Hr was measured right after the second exposure process. The data taken at 24 Hr was measured 24 hours after the second exposure process and operating a backlight unit. Each second exposure was performed for 0 min, 10 min, 20 min, 40 min, or 80 min.

Referring to FIGS. 6A and 6B, the conventional liquid crystal display and the exemplary liquid crystal display had the same structure except for the liquid crystal composition and alignment layers. The conventional liquid crystal display includes a liquid crystal composition lacking a chiral reactive mesogen. On the contrary, the present liquid crystal display includes a liquid crystal composition having the chiral reactive mesogen at 0.4 percent by weight, relative to the total weight of the liquid crystal composition. In FIGS. 6A and 6B, the data taken at 0 Hr was measured right after the second exposure process. The data taken at 24 Hr was measured 24 hours after the second exposure process, while applying a DC voltage of 1V at a temperature of 60° C.

Referring to FIGS. 5A, 5B, 6A, and 6B, the holding ratios of the exemplary embodiment are much better than those of the conventional liquid crystal display, in all conditions. It is understood that the impurities such as alkenyl radicals, alkoxy radicals, peroxide radicals, etc., are removed by reacting with the functional groups of the first and second alignment layers, which are polymerized with the chiral reactive mesogen.

As described above, as the exemplary liquid crystal display has a faster response time and higher contrast ratio, due to the first and second alignment layers being polymerized by the chiral reactive mesogen.

According to another exemplary embodiment of the present invention, a horizontal electric field mode liquid crystal display, such as in plan switching mode liquid crystal display or a partly horizontal electric field and partly fringe electric field mode liquid crystal display, is disclosed.

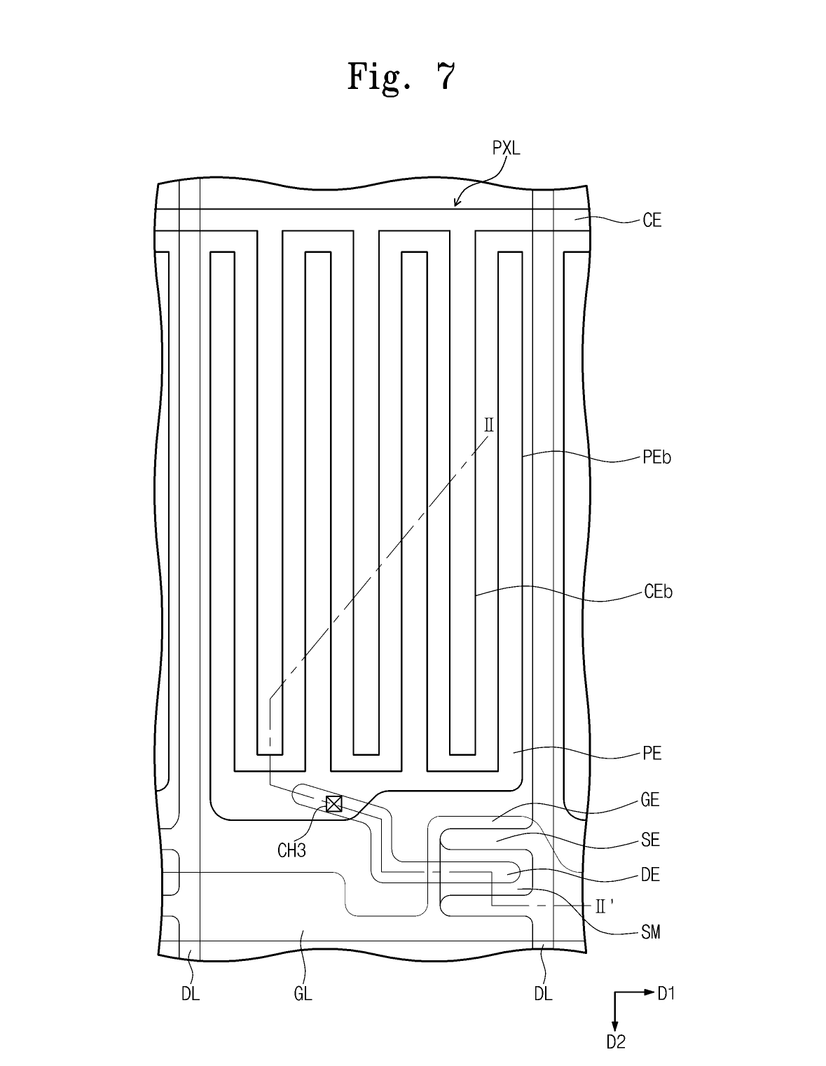

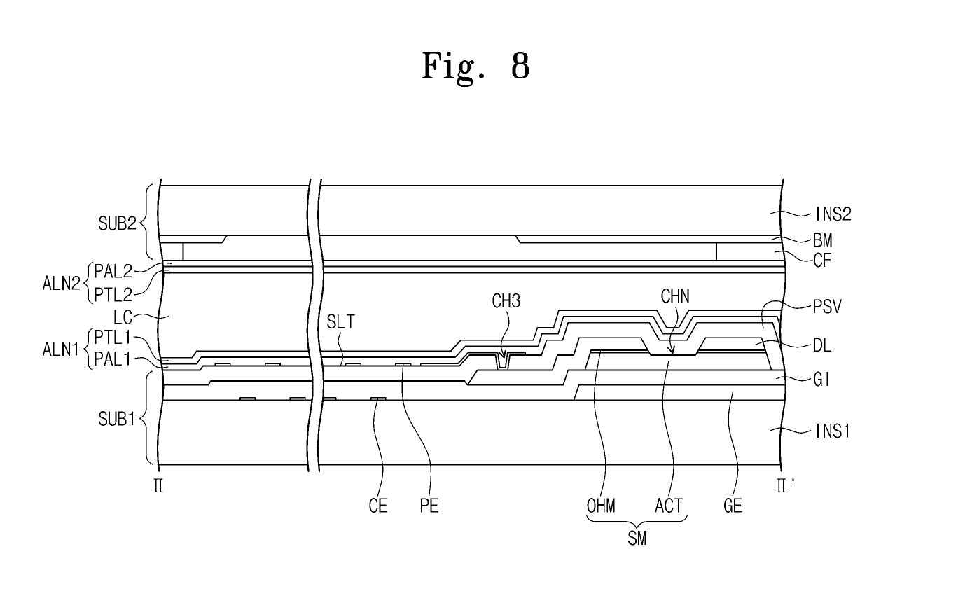

FIG. 7 is a plan view showing one pixel of a liquid crystal display, according to another exemplary embodiment of the present disclosure. FIG. 8 is a cross-sectional view taken along a line II-II′ of FIG. 7. Hereinafter, only the differences between the present exemplary embodiment and the previous exemplary embodiment will be described in detail.

Referring to FIGS. 7 and 8, a common electrode CE is disposed between two adjacent gate lines. The common electrode CE has a plurality of first branches CEb extending in a second direction D2. The common electrode CE in each pixel PXL extends in a first direction D1 and is connected to a portion of the common electrode CE in an adjacent pixel PXL. The portions of the common electrode CE in each pixel PXL receive the same common voltage.

The pixel electrode PE has a plurality of second branches PEb extending in the second direction D2. The first branches CEb of the common electrode CE and the second branches PEb of the pixel electrode PE are spaced apart from each other and are parallel to each other in a plan view. The first branches CEb and the second branches PEb are arranged alternately.

In FIGS. 7 and 8, the intervals between the first branches CEb and the second branches PEb are shown with comparatively a narrow width, but the actual intervals are generally large enough to form a horizontal electric field between the first branches CEb and the second branches PEb. In addition, the pixel electrode PE and the common electrode CE are formed on the different layers, but are not limited thereto. For example, the pixel electrode PE and the common electrode CE may be formed on the same layers, according to some embodiments.

A first alignment layer ALN1 includes a first preliminary alignment layer PAL1 and a first pretilting layer PTL1, and a second alignment layer ALN1 includes a second preliminary alignment layer PAL2 and a second pretilting layer PTL2. The first and second pretilting layers PTL1 and PTL2 include a polymer polymerized by chiral reactive mesogen selected from the compounds of Chemical Formula 1. The liquid crystal display in the horizontal electric field mode has faster response time than that of the conventional liquid crystal display.

Table 2 shows response times of a conventional liquid crystal display and an exemplary liquid crystal display employing the chiral reactive mesogen. The conventional liquid crystal display and the exemplary liquid crystal display have the same structure, except for the liquid crystal composition and alignment layers. The conventional liquid crystal display includes a liquid crystal composition lacking a chiral reactive mesogen. On the contrary, the exemplary liquid crystal display includes liquid crystal composition having a chiral reactive mesogen at about 0.05 percent by weight, relative to the to the total weight of the liquid crystal composition. For making the exemplary liquid crystal display, light exposure conditions are changed to polymerize the chiral reactive mesogen with different irradiation energies.

TABLE 2

| | amount of chiral | irradiation | response | improvement |
|---|---|---|---|---|
| | reactive mesogen | energy of | time | of response |
| | (% by weight) | UV(J) | (Toff, ms) | time (%) |
| conventional | 0 | 0 | 24.34 | standard |
| liquid crystal | | | | |
| display | | | | |
| liquid crystal | 0.05 | 3 | 20.62 | 18% |
| display | | | | |
| (example 1) | | | | |
| liquid crystal | 0.05 | 6 | 18.85 | 29% |
| display | | | | |
| (example 2) | | | | |

As shown in Table 2, the response time of the exemplary liquid crystal display is improved by about 18%, when 3 J of UV light is radiated, and by about 30% when 6 J of UV light is radiated, as compared to that of the conventional liquid crystal display. It is believed that the liquid crystal molecules are well pretilted in an area where the horizontal electric field formed, because the order of the liquid crystal molecules and the elasticity of the liquid crystal molecules are increased. The increase of elasticity is presumed to be due to the on directional rotation of the liquid crystal molecules, according to the chirality of the polymerized reactive mesogen.

Also, if the conventional liquid crystal display is a horizontal electric field mode display, just like the fringe electric field mode display, as liquid crystal molecules are arranged in a direction of major axis and then the director of each liquid crystal molecule is twisted in a state of lower order, the liquid crystal molecules are not easily pretilted. On the contrary, since the present liquid crystal molecules are arranged in a state of higher order using the chirality of the chiral reactive mesogen, the liquid crystal molecules are easily pretilted. In addition, a higher the contrast ratio than that of the conventional liquid crystal display can be produced, due to the higher order of the liquid crystal molecules.

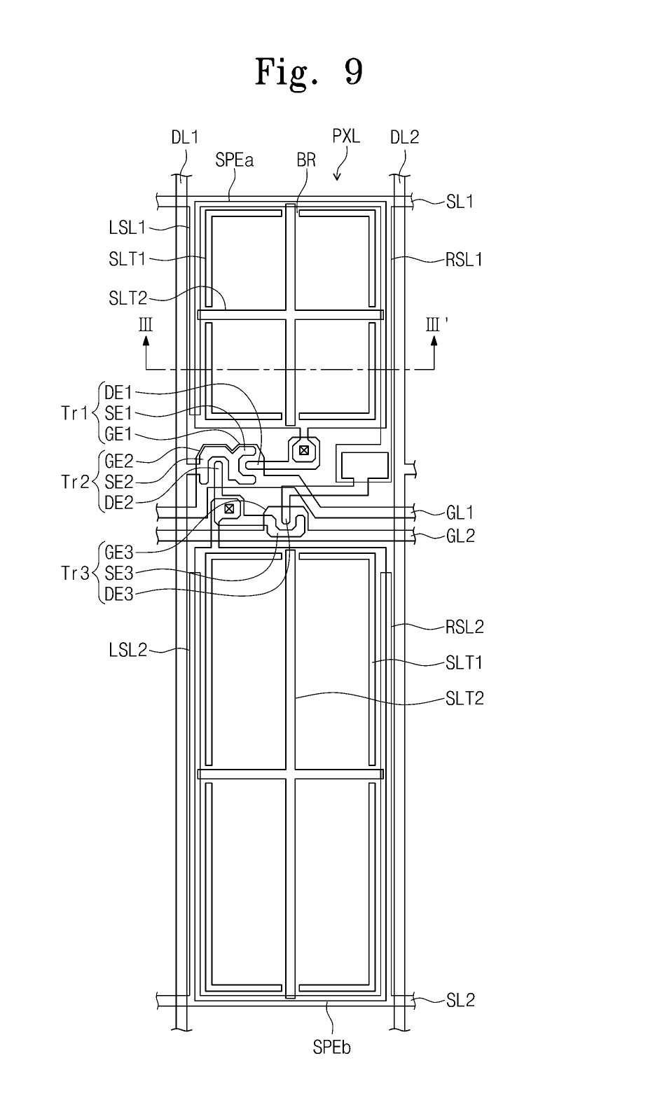

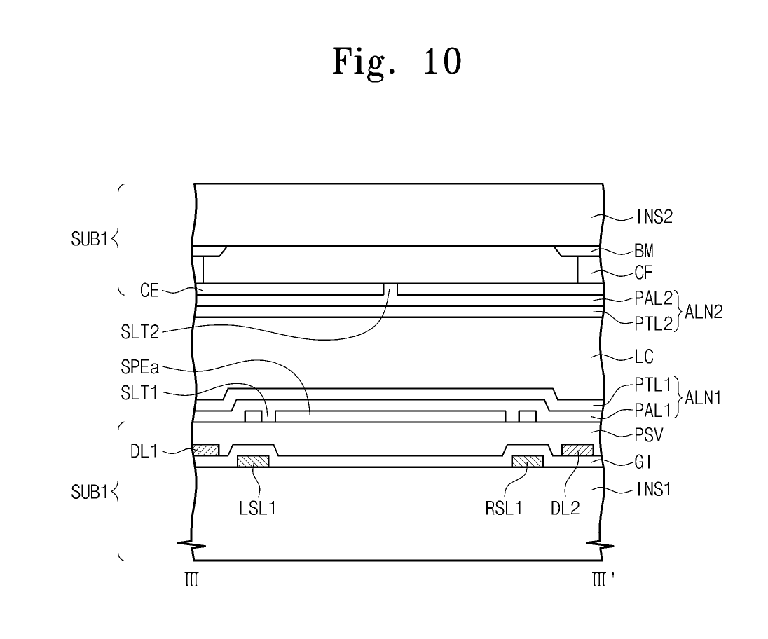

FIG. 9 is a plan view showing one pixel of a liquid crystal display, according to another exemplary embodiment of the present disclosure. FIG. 10 is a cross-sectional view taken along a line III-III′ of FIG. 9. The liquid crystal display comprises a plurality of gate lines, a plurality of data lines, and pixels which are connected with the gate lines and the data lines. In this exemplary embodiment, one pixel with first and second data lines, which are parallel to each other, and first and second gate lines, which cross over and are insulated from the first and second data lines, are described for convenience.

Referring to FIGS. 9 and 10, the liquid crystal display comprises a first substrate SUB1, a first alignment layer ALN1 disposed on the first substrate SUB1, a second substrate SUB2 facing to the first substrate SUB1, a second alignment layer ALN2 disposed on the second substrate SUB2, and liquid crystal layer LC disposed between the first and second alignment layers ALN1 and ALN2.

The first substrate SUB1 comprises a first insulating substrate INS 1 that includes a transparent insulating material. A gate wiring part including the first and second gate lines GL1 and GL2, first and second storage lines SL1 and SL2, and first to fourth branched electrodes LSL1, RSL1, LSL2, and RSL2 is disposed on the first insulating substrate INS 1.

A gate insulator GI is disposed on the first insulating substrate INS 1 to cover the gate wiring part. A data wiring part including the first and second data lines DL1 and DL2 is disposed on the gate insulator GI. A passivation layer PSV covers the data wiring part. A first subpixel electrode SPEa and a second subpixel electrode SPEb are disposed on the passivation layer PSV.

A first alignment layer ALN1 is disposed on the first substrate SUB1 to cover the first subpixel electrode SPEa and the second subpixel electrode SPEb. The first alignment layer ALN1 includes a first preliminary alignment PAL1 and a first pretilting layer PTL1. The first pretilting layer PTL1 includes a chiral reactive mesogen selected from the compounds of Chemical Formula 1, as explained above.

The second substrate SUB2 comprises a second insulating substrate INS2 facing the first insulating substrate INS 1. A color filter CF including red, green, and blue color filer is disposed on the second insulating substrate INS2.

A common electrode CE is provided on the color filter CF. The common electrode CE faces the first subpixel electrode SPEa and the second subpixel electrode SPEb.

A second alignment layer ALN2 is disposed on the common electrode CE. The second alignment layer ALN2 includes a second preliminary alignment layer PAL2 and a second pretilting layer PTL2. The second pretilting layer PTL1 includes chiral a reactive mesogen selected from the compounds of Chemical Formula 1.

Each of the first subpixel electrode SPEa and the second subpixel electrode SPEb is provided with first slits SLT1. For example, when the first subpixel electrode SPEa and the second subpixel electrode SPEb have a rectangular shape, the first slits SLT1 extends along at least one side of the rectangular shape, or along a portion of the first subpixel electrode SPEa and/or the second subpixel electrode SPEb. The first slits SLT1 may include a plurality of sub-slits. The sub-slits may extend along each side of the rectangular shape to be adjacent to the sides. A bridge part BR may be provided at ends of the sub-slits to connect adjacent ends to each other. The bridge part BR may be located at the center of each side of the rectangular shape.

Second slits SLT2 are provided in the common electrode CE and correspond to each of first subpixel electrode SPEa and the second subpixel electrode SPEb. The second slits SLT2 each extend parallel to at least one side of the rectangular shape and may pass over the centers of the first subpixel electrode SPEa and the second subpixel electrode SPEb. For example, the second slits SLT2 may be cross-shaped.

When a voltage is applied to the first subpixel electrode SPEa, the second sub pixel electrode SPEb, and the common electrode CE, a horizontal or fringe electric field is formed in an area of the slits formed of the first subpixel electrode SPEa, the second subpixel electrode SPEb, and the common electrode CE. Namely, the fringe or horizontal electric field is formed in a boundary area of the first subpixel electrode SPEa, in a boundary area of the second subpixel electrode SPEb, and/or in an area corresponding to the cross-shape. Except the area where the first and second slits SLT1 and SLT2 are formed, a vertical electric field is formed between the first and second subpixel electrode SPEa and SPEb and the common electrode CE.

In the embodiment of the present invention, when a voltage is applied to the first and second subpixel electrode SPEa and SPEb and the common electrode CE, liquid crystal molecules near the first and second slits SLT1 and SLT2 are rotated in a specific direction at first, and then liquid crystal molecules in other area are sequentially rotated.

In present exemplary embodiment, the first and second alignment layers ALN1 and ALN2 arrange the liquid crystal molecules in the areas where the first and second slits SLT1 and SLT2 with a stable pretilt angle, in the same way as in the exemplary embodiments explained above. Therefore, the order of liquid crystal molecules increases, and a faster response time is obtained.

Although the exemplary embodiments of the present invention have been described, it is understood that the present invention should not be limited to these exemplary embodiments, and various changes and modifications can be made by one ordinary skilled in the art within the spirit and scope of the present invention as hereinafter claimed.

For instance, the first and second alignment layers are formed by forming first and second preliminary alignment layers, and then forming first and second pretilting layers using chiral reactive mesogen polymerization, but the present disclosure is not limited thereto. That is, the first and second alignment layers may be formed by forming first and second preliminary alignment layers including a chiral reactive mesogen as a functional group, and then exposing the chiral reactive mesogen to polymerize. In this case, the liquid crystal composition may not include the chiral reactive mesogen.

In addition, the exemplary embodiments of the present invention have been individually described, but combinations of those are possible unless their coexistence is impossible.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display apparatus comprising:
a first substrate;
a first alignment layer disposed on the first substrate;
a second substrate facing the first substrate;
a second alignment layer disposed on the second substrate;
a liquid crystal layer disposed between the first alignment layer and the second alignment layer; and
an electrode part disposed on one or both of the first and second substrates, to form an electric field,
wherein the first and second alignment layers each comprise a polymer polymerized from a chiral reactive mesogen comprising a chiral group and a reactive mesogenic group.

2. The liquid crystal display apparatus of claim 1, wherein the electrode part comprises:
a first electrode disposed on the first substrate and comprising first branches; and
a second electrode disposed on the first substrate and spaced apart from the first electrode, the second electrode comprising second branches alternately arranged with the first branches in a plan view, and configured to form a horizontal electric field together with the first branches.

3. The liquid crystal display apparatus of claim 1, wherein the electrode part comprises:
a first electrode disposed on the first substrate; and
a second electrode disposed on the first substrate and spaced apart from the first electrode,
wherein the second electrode comprises branches overlapping the first electrode in a plan view and is configured to form a fringe electric field together with the first electrode.

4. The liquid crystal display apparatus of claim 1, wherein the electrode part comprises:
a rectangular first electrode disposed on the first substrate and comprising a first slit disposed along at least one side of the first electrode; and
a rectangular second electrode disposed on the second substrate and comprising a second slit that passes through the center of the second electrode and is parallel to at least one side of the second electrode,
wherein the first and second electrodes are configured to form the horizontal electric field or a vertical electric field, between the first slit and the second slit.

5. The liquid crystal display apparatus of claim 2, wherein the chiral group comprises a photo-tunable chiral group.

6. The liquid crystal display apparatus of claim 5, wherein the chiral reactive mesogen comprises a compound of Chemical Formula 1:
(R*-(A¹-Z¹)ₘ₁)ₖ-Q,wherein, [Chemical Formula 1]
R* is P-Sp-, H, L, or a straight-chain or branched alkyl group having 1 to 25 C atoms, wherein,
when R* is a straight-chain or branched alkyl group, in which one or more non-adjacent CH₂ groups are optionally independently replaced by —C(R^{x})═C(R^{x})—, —C≡C—, —N(R^{X})—, —O—, —S—, —CO—, —CO—O—, —O—CO—, or —O—CO—O—, in such a way that O atoms, S atoms, and O and S atoms are not linked directly to one another, and in which one or more H atoms are optionally replaced by F, Cl, Br, I, CN, or P-Sp-,
P is CH₂═C(CH₃)—COO—,
Sp is a spacer group or a single bond, and
L is P-Sp-, —OH, —CH₂OH, F, Cl, Br, I, —CN, —NO₂, —NCO, —NCS, —OCN, —SCN, —C(═O)N(R^{X})₂, —C(═O)Y¹, —C(═O)R^{X}, —N(R^{X})₂, a substituted or un-substituted silyl or aryl group having 6 to 20 C atoms, or a straight-chain or branched alkyl, alkoxy, alkylcarbonyl, alkoxycarbonyl, alkylcarbonyloxy, or alkoxycarbonyloxy group having 1 to 25 C atoms, wherein,
one or more H atoms of L are optionally replaced by F, Cl, or P-Sp-,
Y¹ is a halogen, and
R^{X} is P-Sp-, H, a halogen, or a straight-chain, branched, or cyclic alkyl group having 1 to 25 C atoms and in which one or more non-adjacent CH₂ groups is optionally replaced by an —O—, —S—, —CO—, —CO—O—, —O—CO—, or —O—CO—O— group, such that O atoms, S atoms, and O and S atoms are not linked directly to one another, and in which one or more H atoms are optionally replaced by F, Cl, or P-Sp-, a substituted or un-substituted aryl or aryloxy group having 6 to 40 C atoms, or a substituted or un-substituted heteroaryl or heteroaryloxy group having 2 to 40 C atoms,
A¹ is a fused or un-fused aromatic, heteroaromatic, alicyclic, or heterocyclic group having 4 to 25 C atoms, and is optionally mono-substituted or poly-substituted by L,
Z¹ is a fused or un-fused aromatic, heteroaromatic, alicyclic, or heterocyclic group having 4 to 25 C atoms, and is optionally mono-substituted- or poly-substituted by L,
m1 is 0, 1, 2, 3, or 4,
k is 1, 2, 3, 4, 5, or 6, and
Q is a k-valent chiral group that is optionally mono-substituted or poly-substituted by L.

7. The liquid crystal display apparatus of claim 6, wherein:
at least one of the A¹ and Z¹ groups comprises P-Sp-; and
A¹ is a phenyl, thiophenyl, 1,4-phenylene, naphthalene-1,4-diyl, or naphthalene-2,6-diyl group, in which one or more CH groups is optionally replaced by N, a cyclohexane-1,4-diyl in which one or more non-adjacent CH₂ groups are optionally independently replaced by O or S, 1,4-cyclohexenylene, a bicyclo[1.1.1]pentane-1,3-diyl, bicyclo[2.2.2]octane-1,4-diyl, a spiro[3.3]heptane-2,6-diyl, piperidine-1,4-diyl, a decahydronaphthalene-2,6-diyl, 1,2,3,4-tetrahydronaphthalene-2,6-diyl, a indane-2,5-diyl, or an octahydro-4,7-methanoindane-2,5-diyl,
wherein A¹ is optionally mono-substituted or polysubstituted by L.

8. The liquid crystal display apparatus of claim 6, wherein Q is a monovalent group of Chemical Formula 2 or a divalent group of Chemical Formula 3: 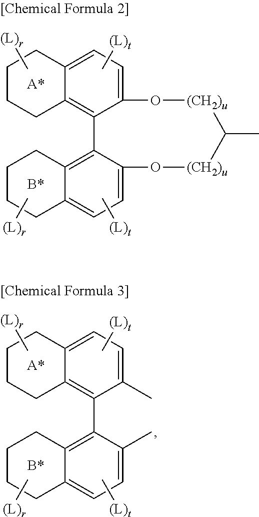
wherein,
each L group is the same or one or more of the L groups are different,
each r is independently 0, 1, 2, 3 or 4,
A* and B* are each independently a fused benzene, a cyclohexane, or a cyclohexene,
each t group is independently 0, 1, or 2, and
each u is independently 0, 1, or 2.

9. The liquid crystal display apparatus of claim 8, wherein Q is at least one compound selected from the compounds of the sub-formulas I11 to II8: 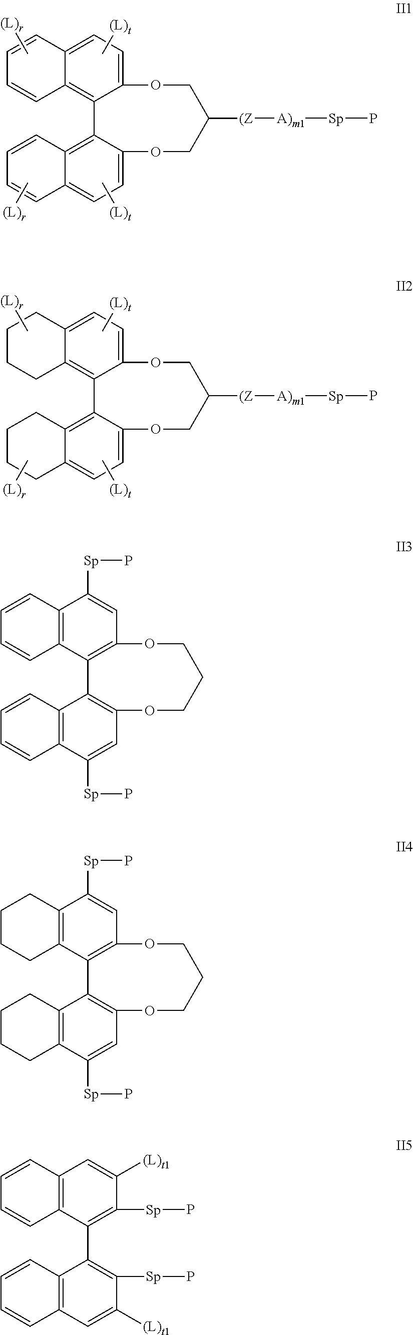 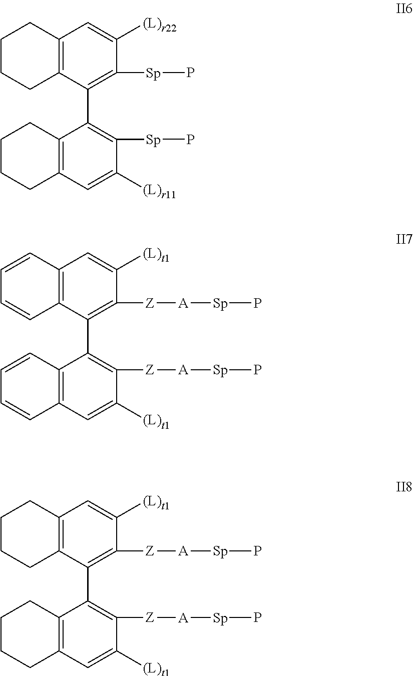
wherein,
each Z is independently selected from the compounds of Z¹, and
each A is independently selected from the compounds of A¹.

10. The liquid crystal display apparatus of claim 9, wherein the liquid crystal layer comprises alkenyl liquid crystal molecules, alkoxy liquid crystal molecules, or a combination thereof.

11. A method of manufacturing a display apparatus, comprising:
forming a first preliminary alignment layer on a first substrate;
forming a second preliminary alignment layer on a second substrate;
disposing a liquid crystal composition between the first and second substrates, the liquid crystal composition comprising a liquid crystal and a chiral reactive mesogen, the chiral reactive mesogen comprising a chiral group and a reactive mesogenic group;
irradiating the liquid crystal composition to form a first pretilting layer on the first preliminary alignment layer and a second pretilting layer on the second preliminary alignment layer.

12. The method of claim 11, wherein the liquid crystal composition comprises about 0.001 percent by weight to 5 percent by weight of the chiral reactive mesogen, based on the total weight of the liquid crystal composition.

13. The method of claim 11, wherein the first and second preliminary alignment layers are aligned by a rubbing or photo-alignment process.

14. The method of claim 11, further comprising applying an electric field to the liquid crystal composition during the irradiating.

15. The method of claim 11, wherein the chiral reactive mesogen comprises a compound of Chemical Formula 1:
(R*-(A¹-Z¹)ₘ₁)ₖ-Q,wherein, [Chemical Formula 1]
R* is P-Sp-, H, L, or a straight-chain or branched alkyl group having 1 to 25 C atoms, wherein,
when R* is a straight-chain or branched alkyl group, in which one or more non-adjacent CH₂ groups are optionally independently replaced by —C(R^{x})═C(R^{x})—, —C≡C—, —N(R^{X})—, —O—, —S—, —CO—, —CO—O—, —O—CO—, or —O—CO—O—, in such a way that O atoms, S atoms, and O and S atoms are not linked directly to one another, and in which one or more H atoms are optionally replaced by F, Cl, Br, I, CN, or P-Sp-,
P is CH₂═C(CH₃)—COO—,
Sp is a spacer group or a single bond, and
L is P-Sp-, —OH, —CH₂OH, F, Cl, Br, I, —CN, —NO₂, —NCO, —NCS, —OCN, —SCN, —C(═O)N(R^{X})₂, —C(═O)Y¹, —C(═O)R^{X}, —N(R^{X})₂, a substituted or un-substituted silyl or aryl group having 6 to 20 C atoms, or a straight-chain or branched alkyl, alkoxy, alkylcarbonyl, alkoxycarbonyl, alkylcarbonyloxy, or alkoxycarbonyloxy group having 1 to 25 C atoms, wherein,
one or more H atoms of L are optionally replaced by F, Cl, or P-Sp-,
Y¹ is a halogen, and
R^{X} is P-Sp-, H, a halogen, or a straight-chain, branched, or cyclic alkyl group having 1 to 25 C atoms and in which one or more non-adjacent CH₂ groups is optionally replaced by an —O—, —S—, —CO—, —CO—O—, —O—CO—, or —O—CO—O— group, such that O atoms, S atoms, and O and S atoms are not linked directly to one another, and in which one or more H atoms are optionally replaced by F, Cl, or P-Sp-, a substituted or un-substituted aryl or aryloxy group having 6 to 40 C atoms, or a substituted or un-substituted heteroaryl or heteroaryloxy group having 2 to 40 C atoms,
A¹ is a fused or un-fused aromatic, heteroaromatic, alicyclic, or heterocyclic group having 4 to 25 C atoms, and is optionally mono-substituted or poly-substituted by L,
Z¹ is a fused or un-fused aromatic, heteroaromatic, alicyclic, or heterocyclic group having 4 to 25 C atoms, and is optionally mono-substituted- or poly-substituted by L,
m1 is 0, 1, 2, 3, or 4,
k is 1, 2, 3, 4, 5, or 6, and
Q is a k-valent chiral group that is optionally mono-substituted or poly-substituted by L.

16. The method of claim 15, wherein Q is a monovalent group of Chemical Formula 2 or a divalent group of Chemical Formula 3: 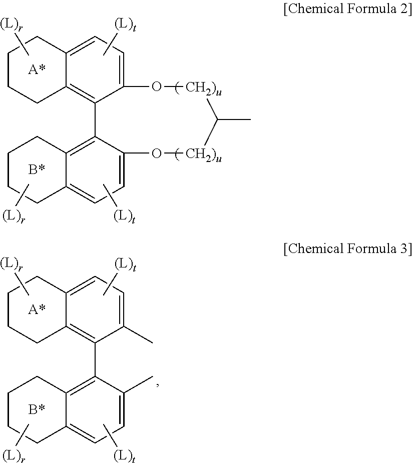
wherein,
each L may be the same or different,
each r is independently 0, 1, 2, 3 or 4,
A* and B* are each independently a fused benzene, a cyclohexane, or a cyclohexene,
each t is independently 0, 1, or 2, and
each u is independently 0, 1, or 2.

17. The method of claim 15, wherein Q is at least one compound selected from the compounds of the Sub-Formulae II1 to II8: 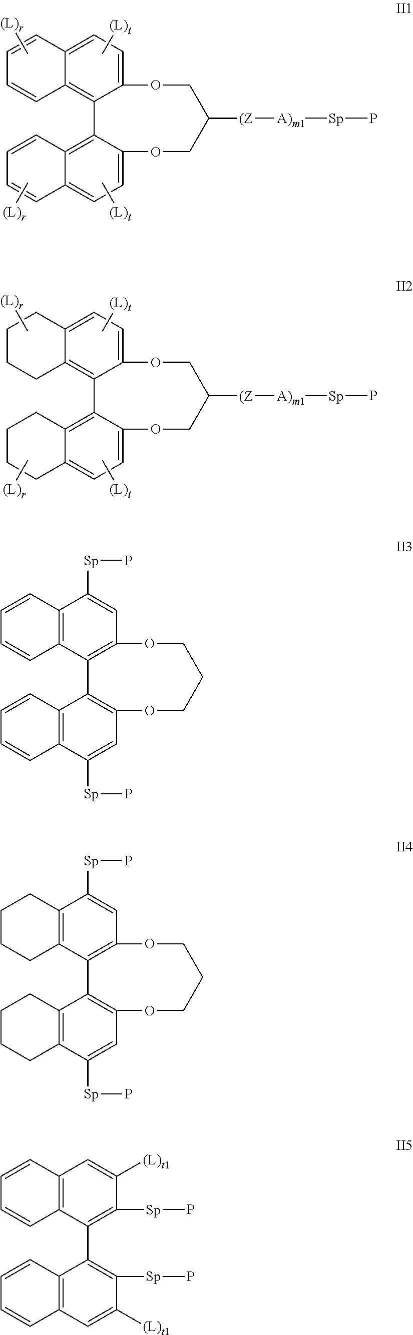 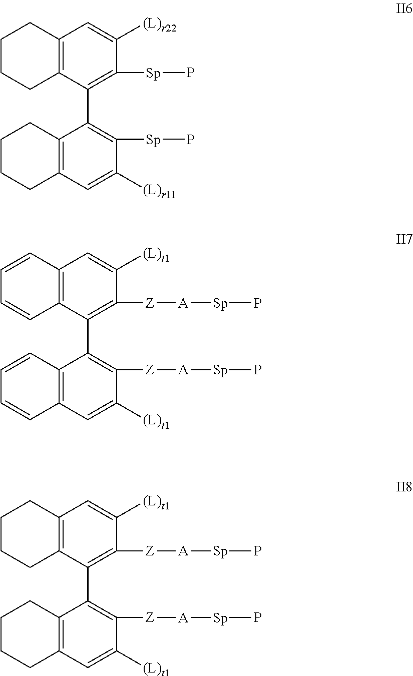
wherein,
each Z is independently selected from the compounds of Z¹, and
each A is independently selected from the compounds of A¹.

18. The method of claim 11, wherein the irradiating is performed at a temperature of about 0° C. to about 60° C.
